(19) United States
(12) Patent Application Publication
(10) Pub. No.: US 2026/0358956 A1
(43) Pub. Date: Nov. 12, 2026

(54) MEMORY DEVICE INCLUDING SHARED BUFFER MEMORY AND OPERATION METHOD THEREOF

(71) Applicant: Samsung Electronics Co., Ltd., Suwon-si (KR)

(72) Inventors: SooYoung Yang, Suwon-si (KR); Kilhwan Kim, Suwon-si (KR)

(73) Assignee: Samsung Electronics Co., Ltd., Suwon-si (KR)

(21) Appl. No.: 19/731,532

(22) Filed: Jul. 6, 2026

(30) Foreign Application Priority Data
Apr. 12, 2025 (KR) 10-2025-0189988

(51) Int. Cl. G06F 3/06

(52) U.S. Cl. CPC G06F 3/061; G06F 3/0631; G06F 3/0679

(57) ABSTRACT

An operation method of a memory device includes selecting a first dedicated region and a first shared region from a first buffer region accessed by a first IP block of a storage controller, selecting a second dedicated region and a second shared region from a second buffer region accessed by a second IP block of the storage controller, determining an integrated shared region including the first shared region and the second shared region, and accessed by the first and second IP blocks, comparing a remaining space of the first dedicated region with a blocking threshold region when the first IP block accesses the integrated shared region, and blocking access to the integrated shared region by the second IP block when a remaining space of the first dedicated region is smaller than the blocking threshold region.

### CROSS-REFERENCE TO RELATED APPLICATIONS

This present application claims priority to and the benefit under 35 U.S.C. § 119(a)-(d) of Korean Patent Application No. 10-2025-0189988, filed on Dec. 4, 2025, in the Korean Intellectual Property Office, the entire disclosure of which is incorporated herein by reference.

### BACKGROUND

### Field

The present disclosure relates to a memory device, and more particularly, to a memory device including a shared buffer memory and operation method thereof.

### Related Art

A semiconductor memory is classified into a volatile memory device, such as SRAM and DRAM, in which stored data is lost when power supply is cut off, and a non-volatile memory device, such as a flash memory device, PRAM, MRAM, RRAM, and FRAM, which retain stored data even when power supply is cut off.

A storage controller of a semiconductor memory uses a buffer memory to temporarily store data when performing a data processing operation or a memory maintenance. However, a buffer region accessed by one IP block cannot be accessed by another IP block, and thus, when the workload of an IP block temporarily increases, there is a problem in that the buffer memory is not efficiently utilized.

### SUMMARY

According to some embodiments of the present disclosure, an operation method of a memory device may include: selecting a first dedicated region and a first shared region from a first buffer region accessed by a first IP block (intellectual property) of a storage controller; selecting a second dedicated region and a second shared region from a second buffer region accessed by a second IP block of the storage controller; determining an integrated shared region including the first shared region and the second shared region, and accessed by the first and second IP blocks; comparing a remaining space of the first dedicated region with a blocking threshold region when the first IP block accesses the integrated shared region; and blocking the second IP block from accessing the integrated shared region when the remaining space of the first dedicated region is smaller than the blocking threshold region, wherein access to the second dedicated region by the first IP block is blocked, and wherein access to the first dedicated region by the second IP block is blocked.

According to some embodiments of the present disclosure, an operation method of a memory device may include: selecting a first dedicated region and a first shared region from a first buffer region accessed by a first IP (intellectual property) block of a storage controller; selecting a second dedicated region and a second shared region from a second buffer region accessed by a second IP block of the storage controller; determining an integrated shared region including the first shared region and the second shared region and accessed by the first and second IP blocks; comparing a remaining space of the integrated shared region with a first expansion threshold region when the first IP block accesses the integrated shared region; comparing a remaining space of the second dedicated region with a second expansion threshold region when the remaining space of the integrated shared region is smaller than the first expansion threshold region; and expanding the integrated shared region to include a portion of the second dedicated region when the remaining space of the second dedicated region is larger than the second expansion threshold region, wherein access to the second dedicated region by the first IP block is blocked, wherein access to the first dedicated region by the second IP block is blocked, wherein the first expansion threshold region includes a portion of the integrated shared region, and wherein the second expansion threshold region includes a portion of the second dedicated region.

According to some embodiments of the present disclosure, a memory device including a storage controller, the storage controller comprising: a shared buffer memory including a first buffer region and a second buffer region; a first IP (intellectual property) block accessing the first buffer region; a second IP block accessing the second buffer region; and a shared buffer manager configured to select a first dedicated region and a first shared region from the first buffer region, to select a second dedicated region and a second shared region from the second buffer region, to determine an integrated shared region including the first shared region and the second shared region, and accessed by the first and second IP blocks, to compare a remaining space of the first dedicated region with a blocking threshold region when the first IP block accesses the integrated shared region, and to block the second IP block from accessing the integrated shared region when the remaining space of the first dedicated region is smaller than the blocking threshold region, wherein access to the second dedicated region by the first IP block is blocked, and wherein access to the first dedicated region by the second IP block is blocked.

### BRIEF DESCRIPTION OF THE DRAWINGS

The above and other objects and features will be more apparent from the following description of embodiments, taken in conjunction with the accompanying drawings, in which:

FIG. 1 is a block diagram illustrating an example storage system according to some embodiments of the present disclosure.

FIG. 2 is a block diagram illustrating an example implementation of the storage controller of FIG. 1.

FIG. 3 is a block diagram illustrating example devices of a storage controller that uses a shared buffer memory.

FIG. 4 is a flowchart illustrating an example operation method of a shared buffer manager according to some embodiments of the present disclosure.

FIGS. 5A and 5B are drawings for illustrating an example operation of determining an integrated shared region of a shared buffer memory.

FIGS. 6A to 6C are drawings for illustrating an example operation of determining an integrated shared region of a shared buffer memory.

FIG. 7 is a diagram for illustrating an example order in which dedicated regions of the shared buffer memory, for which an integrated shared region has been determined, are used.

FIG. 8 is a flowchart for illustrating an example operation of blocking access to an integrated shared region.

FIGS. 9A and 9B are drawings for illustrating an example operation of blocking access to an integrated shared region.

FIG. 10 is a flowchart for illustrating an example operation of expanding an integrated shared region.

FIGS. 11A and 11B are drawings for illustrating an example operation of expanding an integrated shared region.

FIGS. 12A to 12C are drawings for illustrating an example operation of expanding an integrated shared region.

FIGS. 13A to 13D are drawings for illustrating an example operation of expanding an integrated shared region.

### DETAILED DESCRIPTION

Below, embodiments of the present disclosure will be described in detail and clearly to such an extent that an ordinary one in the art easily carries out the present disclosure.

An object of the present disclosure is to provide a memory device and an operation method thereof having improved performance and improved reliability.

A storage controller of a semiconductor memory uses buffer memory to temporarily store data when performing data processing tasks or memory maintenance tasks. The buffer memory includes a buffer area allocated to each of IP (intellectual property) blocks contained within the storage controller.

In some conventional storage controllers, the buffer memory is divided into a first buffer area that can be accessed only by a first IP block of the storage controller and a second buffer area that can be accessed only by a second IP block of the storage controller. It has been recognized within the context of the present disclosure that when a workload of one IP block temporarily increases, since the IP block can access only the buffer area allocated thereto, there is a technological problem that the IP block cannot access remaining space of a buffer area allocated to another IP block even though the remaining space is sufficient. It has been recognized within the context of the present disclosure that this is not efficient in terms of resource management of the buffer memory. Accordingly, it has been recognized within the context of the present disclosure that storage controllers and/or, more generally, semiconductor memory, can be improved by providing a shared buffer memory that can be shared by the IP blocks in consideration of the remaining space of the buffer memory.

The present disclosure overcomes the aforementioned technological challenges by providing an integrated shared region of a buffer memory that can be accessed jointly by IP blocks of a storage controller. For example, the shared buffer manager of the present disclosure may determine the integrated shared region by selecting a first shared region from a first buffer region accessible to a first IP block and selecting a second shared region from a second buffer region accessible to a second IP block. When the integrated shared region is not determined, each of the IP blocks is permitted to access only its allocated buffer region. However, in some embodiments, when the integrated shared region is determined, each of the IP blocks may access not only its allocated buffer region but also the integrated shared region. Beneficially, buffer memory resources can be utilized more efficiently, and even when the workload of a particular IP block temporarily increases, performance degradation can be prevented through the integrated shared region.

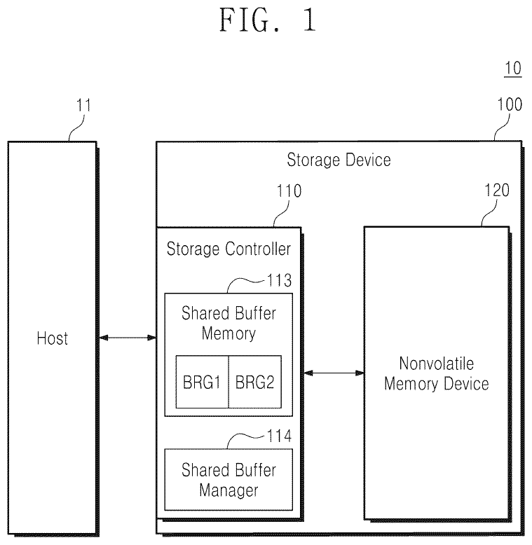

FIG. 1 is a block diagram illustrating a storage system according to some embodiments of the present disclosure. Referring to FIG. 1, the storage system 10 may include a host 11 and a storage device 100. In some embodiments, the storage system 10 may include at least one of a plurality of information processing devices, such as a personal computer, a laptop computer, a server, a workstation, a smartphone, a tablet PC and the like. In some embodiments, the host 11 may be processor circuitry. Examples of the processor circuitry include a central processing unit (CPU), a digital signal processor (DSP), a field programmable gate array (FPGA), a graphics processing unit (GPU), and a microcontroller. Alternatively or additionally, the storage system 10 may be a data center configured to store and manage various data, or may be a storage server or an application server included in the data center.

The host 11 may be configured to control the storage device 100. For example, the host 11 may store data in the storage device 100 or may read stored data from the storage device 100.

The storage device 100 may include a storage controller 110 and a non-volatile memory device 120. In some embodiments, the storage device 100 may be a mass storage device, such as an SSD (Solid State Drive) or a UFS (Universal Flash Storage) card, configured to store data in a computing system. However, the scope of the present disclosure is not limited thereto. Alternatively or additionally, the storage device 100 may be included in a mobile system, such as a mobile phone, a smartphone, a tablet PC, a wearable device, a healthcare device, or an IoT (Internet of Things) device. Alternatively or additionally, the storage device 100 may be included in a personal computer, a laptop computer, a server, a media player, or an automotive device such as a navigation device.

The storage controller 110 may be configured to control the non-volatile memory device 120. For example, the storage controller 110 may store data in the non-volatile memory device 120 or may read data stored in the non-volatile memory device 120.

The non-volatile memory device 120 may operate under the control of the storage controller 110. For example, the non-volatile memory device 120 may, in response to signals received from the storage controller 110, store received data or output stored data. In some embodiments, the non-volatile memory device 120 may be a flash memory device. However, the scope of the present disclosure is not limited thereto.

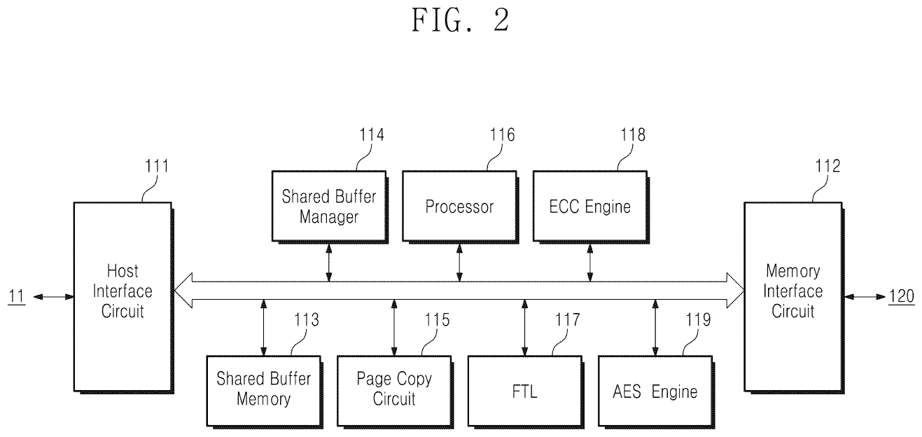

In some embodiments, the storage controller 110 may include a shared buffer memory 113 and a shared buffer manager 114. The shared buffer memory 113 may be a memory that is temporarily used by IP (intellectual property) blocks included in the storage controller 110. The IP blocks included in the storage controller 110 may temporarily use the shared buffer memory 113 when performing a data write/read operation or a storage maintenance or management operation. In some embodiments, the IP blocks included in the storage controller 110 may include a host interface circuit, a memory interface circuit, a page copy circuit, and an ECC (error correction code) engine. The IP blocks may be configured as hardware, software, or a combination thereof to perform various functions of the storage controller 110. The IP blocks included in the storage controller 110 will be described in more detail with reference to FIG. 2.

In some embodiments, the shared buffer memory 113 may include first and second buffer regions BRG1 and BRG2, which may also be referred to as memory regions. The first and second buffer regions BRG1 and BRG2 may be buffer regions used by the two IP blocks that request access to the first and second buffer regions BRG1 and BRG2 among the IP blocks included in the storage controller 110. For example, the first buffer region BRG1 may be temporarily used by a first IP block of the storage controller 110, and the second buffer region BRG2 may be temporarily used by a second IP block of the storage controller 110.

In some embodiments, a first IP block of the storage controller 110 that accesses the first buffer region BRG1 may be blocked (e.g., prevented) from accessing the second buffer region BRG2, and a second IP block of the storage controller 110 that accesses the second buffer region BRG2 may be blocked (e.g., prevented) from accessing the first buffer region BRG1.

In some embodiments, access to the first and second buffer regions BRG1 and BRG2 may be performed in an FCFS (first-come, first-served) manner. For example, based on the order of access requests to the first and second buffer regions BRG1 and BRG2, the IP blocks of the storage controller 110 may access the first and second buffer regions BRG1 and BRG2. Alternatively, access to the first and second buffer regions BRG1 and BRG2 may be performed differently, such as based on priority scheduling or shortest job first (SJF).

In some embodiments, the shared buffer memory 113 may be an SRAM (static random access memory). However, the scope of the present disclosure is not limited thereto. For example, the shared buffer memory 113 may be a memory that temporarily stores data, such as DRAM or Embedded DRAM.

The shared buffer manager 114 may allocate the shared buffer memory 113 to the IP blocks of the storage controller 110. For example, when the IP blocks included in the storage controller 110 request access to the shared buffer memory 113, the shared buffer manager 114 may allocate the shared buffer memory 113 according to the order of the access requests. For example, the shared buffer manager 114 may allocate the first buffer region BRG1 of the shared buffer memory 113 to an IP block of the storage controller 110 having the first request order and may allocate the second buffer region BRG2 of the shared buffer memory 113 to an IP block of the storage controller 110 having the second request order.

In general, a first IP block of the storage controller 110 allocated to the first buffer region BRG1 cannot access the second buffer region BRG2, and a second IP block of the storage controller 110 allocated to the second buffer region BRG2 cannot access the first buffer region BRG1. In this case, even though sufficient remaining space exists in one buffer region, an IP block of the storage controller allocated another buffer region cannot utilize the remaining space. Accordingly, the buffer regions BRG1 and BRG2 are not efficiently utilized.

According to some embodiments of the present disclosure, the shared buffer manager 114 may determine a shared region by selecting a portion of the first buffer region BRG1 of the shared buffer memory 113 and selecting a portion of the second buffer region BRG2. When the shared region is determined, a first IP block of the storage controller 110 allocated to the first buffer region BRG1 may access not only the first buffer region BRG1 but also the shared region, and a second IP block of the storage controller 110 allocated to the second buffer region BRG2 may access not only the second buffer region BRG2 but also the shared region. Beneficially, when a workload of one IP block temporarily increases, performance degradation may be prevented through the shared region.

In addition, when little remaining space exists in one buffer region, the shared buffer manager 114 may block an IP block of the storage controller allocated to another buffer region from accessing the shared region, or may expand the shared region when little remaining space exists in the shared region. Beneficially, reliability of the IP block of the storage controller allocated to the shared buffer memory 113 may be improved.

FIG. 2 is a block diagram illustrating the storage controller shown in FIG. 1. Referring to FIGS. 1 and 2, the storage controller 110 may include a host interface circuit 111, a memory interface circuit 112, a shared buffer memory 113, a shared buffer manager 114, a page copy circuit 115, a processor 116, an FTL (flash translation layer) 117, an ECC engine 118, and an AES (advanced encryption standard) engine 119.

The host interface circuit 111 may communicate with the host 11. In some embodiments, the host interface circuit 111 may be configured to comply with a predetermined interface, communication protocol, or communication standard defined between the host 11 and the storage device 100. In some embodiments, the host interface circuit 111 may be configured to comply with an NVMe (Non-Volatile Memory Express) standard. However, the scope of the present disclosure is not limited thereto.

The memory interface circuit 112 may communicate with the non-volatile memory device 120. For example, the memory interface circuit 112 may access or control the non-volatile memory device 120. For example, the memory interface circuit 112 may control the non-volatile memory device 120 to read data stored in the non-volatile memory device 120 or write data to the non-volatile memory device 120. In some embodiments, the memory interface circuit 112 may include a flash controller configured to control the non-volatile memory device 120. In some embodiments, the memory interface circuit 112 may be configured to comply with a predetermined interface, communication protocol, or communication standard. The predetermined interface, communication protocol, or communication standard may be a standard protocol such as Toggle or ONFI (Open NAND Flash Interface). However, the scope of the present disclosure is not limited thereto.

The shared buffer memory 113 may temporarily provide a buffer region to devices included in the storage controller 110. For example, the devices included in the storage controller 110, such as the host interface circuit 111, the memory interface circuit 112, the page copy circuit 115, the ECC engine 118, or the AES engine 119, may temporarily store data generated while performing data input/output operations, memory maintenance, or management operations.

The shared buffer manager 114 may allocate the shared buffer memory 113 to the IP blocks included in the storage controller 110. For example, the shared buffer manager 114 may allocate the shared buffer memory 113 based on the orders of access requests to the shared buffer memory 113.

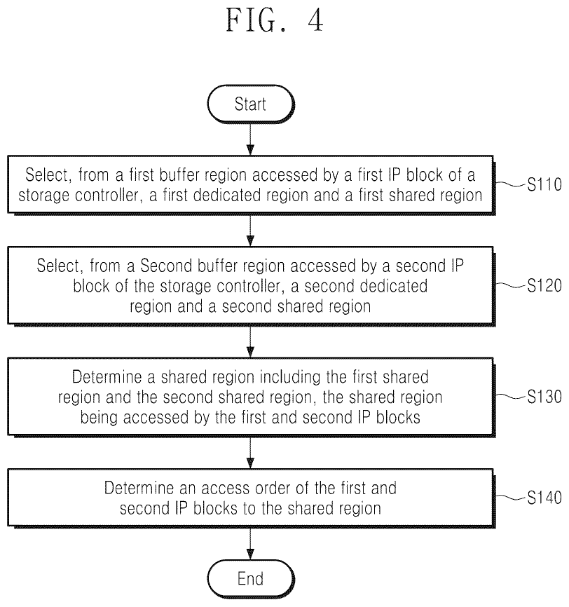

In some embodiments, the shared buffer manager 114 may perform maintenance or management operation for the shared buffer memory 113. For example, the shared buffer manager 114 may determine a shared region based on the first and second buffer regions BRG1 and BRG2 of the shared buffer memory 113. Alternatively or additionally, when available resources in one buffer region are insufficient, the shared buffer manager 114 may block IP blocks of the storage controller 110 accessing another buffer region from accessing the shared region. Alternatively or additionally, when available resources in the shared region are insufficient, the shared buffer manager 114 may expand the shared region. The maintenance or management operations of the shared buffer manager 114 for the shared buffer memory 113 will be described in more detail with reference to FIGS. 4 to 13D.

The page copy circuit 115 may perform an operation for copying data from a source page (e.g., a source memory page) to a target page (e.g., a target memory page) after reading the data from the source page during garbage collection or an internal data transfer process. The page copy circuit 115 may use the shared buffer memory 113 to temporarily store intermediate data required during garbage collection or an internal data relocation process. In addition, the page copy circuit 115 may be allocated buffer regions from the shared buffer memory 113 and use them to temporarily store metadata or operation results generated during an operation process.

The processor 116 may be configured to control overall operations of the storage controller 110. For example, the processor 116 may execute various applications running in the storage controller 110.

The FTL 117 may perform maintenance operations to efficiently manage or use the non-volatile memory device 120. Examples of the maintenance operations include an address mapping operation, a wear-leveling operation, and a garbage collection operation.

The address mapping operation may be an operation of mapping a logical address received from the host 11 into a physical address. For example, the physical address may be used to actually store data in the non-volatile memory device 120.

The wear-leveling operation may be an operation for preventing excessive wear of a particular memory block among memory blocks included in the non-volatile memory device 120. For example, the FTL 117 may allocate the memory blocks included in the non-volatile memory device 120 so that the memory blocks are used uniformly, thereby preventing excessive wear of a particular memory block. In some embodiments, the wear-leveling operation of the FTL 117 may be implemented through a firmware technique that balances the erase count of the memory blocks of the non-volatile memory device 120.

The garbage collection operation may be an operation for obtaining available blocks or capacity of the non-volatile memory device 120. For example, after copying valid data of a source memory block to a target memory block, the FTL 117 may convert the source memory block into a free block or erase the source memory block.

In addition to the operations described above, the FTL 117 may further perform various maintenance operations such as read reclaim, patrol read, periodic refresh, and bad block management, and the like. In some embodiments, some or all functions of the FTL 117 may be implemented using software, hardware, or a combination thereof.

The ECC engine 118 may perform error detection and correction for read data read from the non-volatile memory device 120. For example, the ECC engine 118 may generate parity bits for write data to be written to the non-volatile memory device 120, and the generated parity bits may be stored in the non-volatile memory device 120 together with the write data. When data is read from the non-volatile memory device 120, the ECC engine 118 may correct errors in the read data using the parity bits read from the non-volatile memory device 120 together with the read data, and may output the error-corrected read data.

The AES engine 119 may perform, using a symmetric-key algorithm, at least one of an encryption operation or a decryption operation on data input to the storage controller 110.

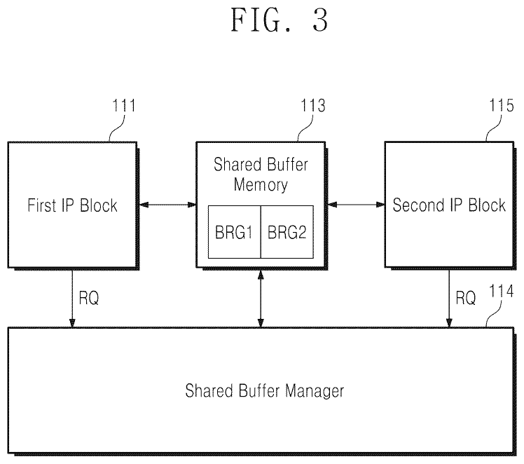

FIG. 3 is a block diagram illustrating an operation for allocating the shared buffer memory 113. Referring to FIGS. 1 and 3, a first IP block 111, the shared buffer memory 113, the shared buffer manager 114, and a second IP block 115 are illustrated. The host interface circuit 111 of FIG. 2 is shown as the first IP block 111, such that the first IP block 111 may be implemented by a portion of the host interface circuit 111. The page copy circuit 115 of FIG. 2 is shown as the second IP block 115, such that the second IP block 115 may be implemented by a portion of the page copy circuit 115. In FIG. 3, the first IP block 111 requesting access to the shared buffer memory 113 may be a host interface circuit 111 of FIG. 2, and the second IP block 115 requesting access to the shared buffer memory 113 may be a page copy circuit 115. However, the scope of the present disclosure is not limited thereto. For example, the IP blocks of the storage controller 110 may include the ECC engine 118 or the AES engine 119, and the like, illustrated in FIG. 2. In such an example, the first IP block 111 and/or the second IP block 115 may be implemented by different portion(s) of different components shown in FIG. 2. The IP blocks may be configured as hardware, software, or a combination thereof to perform various functions of the storage controller 110.

The first IP block 111 and the second IP block 115 may request RQ (receive queue) access to the shared buffer memory 113 to the shared buffer manager 114. For example, the first IP block 111 and the second IP block 115 may request RQ access to the first and second buffer regions BRG1 and BRG2 of the shared buffer memory 113.

The shared buffer manager 114 may determine the order of access requests to the shared buffer memory 113. For example, the shared buffer manager 114 may determine the order of access requests made by the first IP block 111 and the second IP block 115.

In some embodiments, the shared buffer manager 114 may allocate the shared buffer memory 113 in response to the request RQ. For example, the shared buffer manager 114 may allocate the first buffer region BRG1 of the shared buffer memory 113 to the first IP block 111 in response to the request RQ from the first IP block 111. The shared buffer manager 114 may allocate the second buffer region BRG2 of the shared buffer memory 113 to the second IP block 115 in response to the request RQ from the second IP block 115. The first IP block allocated to the first buffer region BRG1 may be blocked from accessing the second buffer region BRG2, and the second IP block allocated to the second buffer region BRG2 may be blocked from accessing the first buffer region BRG1.

FIG. 4 is a flowchart illustrating an operation method of the shared buffer manager according to some embodiments of the present disclosure. In FIG. 4, the IP blocks of the storage controller 110 are described as being allocated the shared buffer memory 113. For example, a first IP block of the storage controller 110, such as a host interface circuit 111, is described as being allocated the first buffer region BRG1 of the shared buffer memory 113, and a second IP block of the storage controller 110, such as a page copy circuit 115, is described as being allocated the second buffer region BRG2 of the shared buffer memory 113.

Referring to FIGS. 1 to 4, in step S110, the shared buffer manager 114 may select a first dedicated region and a first shared region from the first buffer region BRG1 accessed by the first IP block of the storage controller 110. The first dedicated region may be a buffer region accessible only by the first IP block. For example, a second IP block may be blocked from accessing the first dedicated region. The first shared region may be a buffer region accessible by both the first and second IP blocks.

In step S120, the shared buffer manager 114 may select a second dedicated region and a second shared region from the second buffer region BRG2 accessed by the second IP block of the storage controller 110. The second dedicated region may be a buffer region accessible only by the second IP block. For example, the first IP block may be blocked from accessing the second dedicated region. The second shared region may be a buffer region accessible by both the first and second IP blocks.

In step S130, the shared buffer manager 114 may determine an integrated shared region that includes the first and second shared regions and that is accessed by the first and second IP blocks. For example, the shared buffer manager 114 may determine the integrated shared region based on the first and second shared regions determined in steps S110 and S120.

In step S140, the shared buffer manager 114 may determine the order of access by the first and second IP blocks to the integrated shared region. For example, the shared buffer manager 114 may determine the order of access to the determined integrated shared region based on the order of access requests to the shared buffer memory 113. For example, when the order of requests of the first IP block of the storage controller 110 is earlier than the order of requests of the second IP block of the storage controller 110, the shared buffer manager 114 may determine that the first IP block has access priority to the integrated shared region. Alternatively or additionally, when the order of requests of the second IP block of the storage controller 110 is earlier than the order of requests of the first IP block of the storage controller 110, the shared buffer manager 114 may determine that the second IP block has access priority to the integrated shared region.

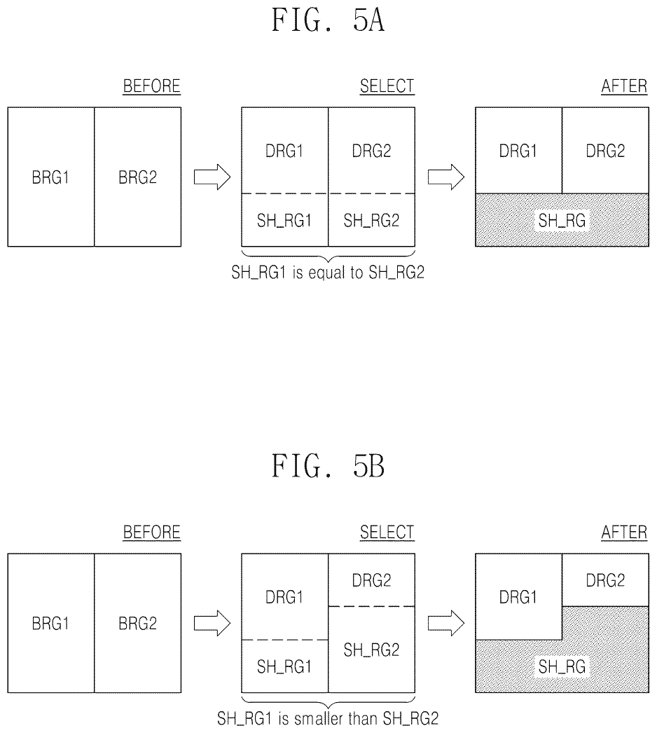

FIGS. 5A and 5B are diagrams illustrating an operation of determining an integrated shared region of the shared buffer memory 113. In FIGS. 5A and 5B, the first buffer region BRG1 is described as being allocated to a first IP block of the storage controller 110 (e.g., a host interface circuit 111) and the second buffer region BRG2 is described as being allocated to a second IP block of the storage controller 110 (e.g., a page copy circuit 115). The first IP block of the storage controller 110 allocated to the first buffer region BRG1 may access the first buffer region BRG1 but may be blocked from accessing the second buffer region BRG2. The second IP block of the storage controller 110 allocated to the second buffer region BRG2 may access the second buffer region BRG2 but may be blocked from accessing the first buffer region BRG1.

First, referring to FIGS. 1, 2, 3, 4, and 5A, before determining the integrated shared region SH_RG, the shared buffer memory 113 may include a first buffer region BRG1 and a second buffer region BRG2 (depicted as BEFORE). In some embodiments, a size of the first buffer region BRG1 may be equal to a size of the second buffer region BRG2. For example, the sizes of the first buffer region BRG1 and the second buffer region BRG2 may be the same.

In some embodiments, to determine the integrated shared region SH_RG, the shared buffer manager 114 may select portions of the first and second buffer regions BRG1 and BRG2 of the shared buffer memory 113 (depicted as SELECT). For example, the shared buffer manager 114 may select a first dedicated region DRG1 and a first shared region SH_RG1 from the first buffer region BRG1, and may select a second dedicated region DRG2 and a second shared region SH_RG2 from the second buffer region BRG2. The first dedicated region DRG1 may be a buffer region that allows access only by the first IP block and blocks access by the second IP block. The second dedicated region DRG2 may be a buffer region that allows access only by the second IP block and blocks access by the first IP block. The first shared region SH_RG1 may be a buffer region of the first buffer region BRG1 to be shared with the second IP block. The second shared region SH_RG2 may be a buffer region of the second buffer region BRG2 to be shared with the first IP block. In some embodiments, the size of the selected first shared region SH_RG1 may be equal to the size of the second shared region SH_RG2.

In some embodiments, the shared buffer manager 114 may determine an integrated shared region SH_RG that includes the first shared region SH_RG1 and the second shared region SH_RG2 (depicted as AFTER). The integrated shared region SH_RG may be a buffer region accessible to both the first and second IP blocks. The first IP block may access not only the first dedicated region DRG1 but also the integrated shared region SH_RG, and the second IP block may access not only the second dedicated region DRG2 but also the integrated shared region SH_RG. That is, compared to before determination of the shared region SH_RG, the size of buffer region accessible by the first and second IP blocks of the storage controller 110 may increase after the integrated shared region SH_RG is determined.

Next, referring to FIGS. 1, 2, 3, 4, and 5B, the shared buffer memory 113 before determination of the integrated shared region SH_RG may include a first buffer region BRG1 and a second buffer region BRG2 (depicted as BEFORE). In some embodiments, the size of the first buffer region BRG1 and the second buffer region BRG2 may be equal to each other.

In some embodiments, to determine the integrated shared region SH_RG, the shared buffer manager 114 may select portions of the first and second buffer regions BRG1 and BRG2 of the shared buffer memory 113 (depicted as SELECT). For example, the shared buffer manager 114 may select a first dedicated region DRG1 and a first shared region SH_RG1 from the first buffer region BRG1, and may select a second dedicated region DRG2 and a second shared region SH_RG2 from the second buffer region BRG2. In some embodiments, the size of the selected first shared region SH_RG1 may be smaller than the size of the selected second shared region SH_RG2.

In some embodiments, the shared buffer manager 114 may determine an integrated shared region SH_RG that includes the first shared region SH_RG1 and the second shared region SH_RG2 (depicted as AFTER). The integrated shared region SH_RG may be a buffer region accessible to both the first and second IP blocks. The first IP block may access not only the first dedicated region DRG1 but also the integrated shared region SH_RG, and the second IP block may access not only the second dedicated region DRG2 but also the integrated shared region SH_RG. That is, compared to the state before determination of the integrated shared region SH_RG, the size of the buffer region accessible by the first and second IP blocks of the storage controller 110 may increase after the integrated shared region SH_RG is determined.

Compared with FIG. 5A, in FIG. 5B, the size of the integrated shared region SH_RG accessible by the first IP block may increase. For example, because the size of the second shared region SH_RG2 selected in FIG. 5B is larger than the size of the second shared region SH_RG2 selected in FIG. 5A, the size of the integrated shared region SH_RG accessible by the first IP block may increase. The operation of determining the shared region SH_RG of the shared buffer memory 113, in which the first and second buffer regions BRG1 and BRG2 have equal sizes as described with reference to FIGS. 5A and 5B, is merely an example, and the scope of the present disclosure is not limited thereto.

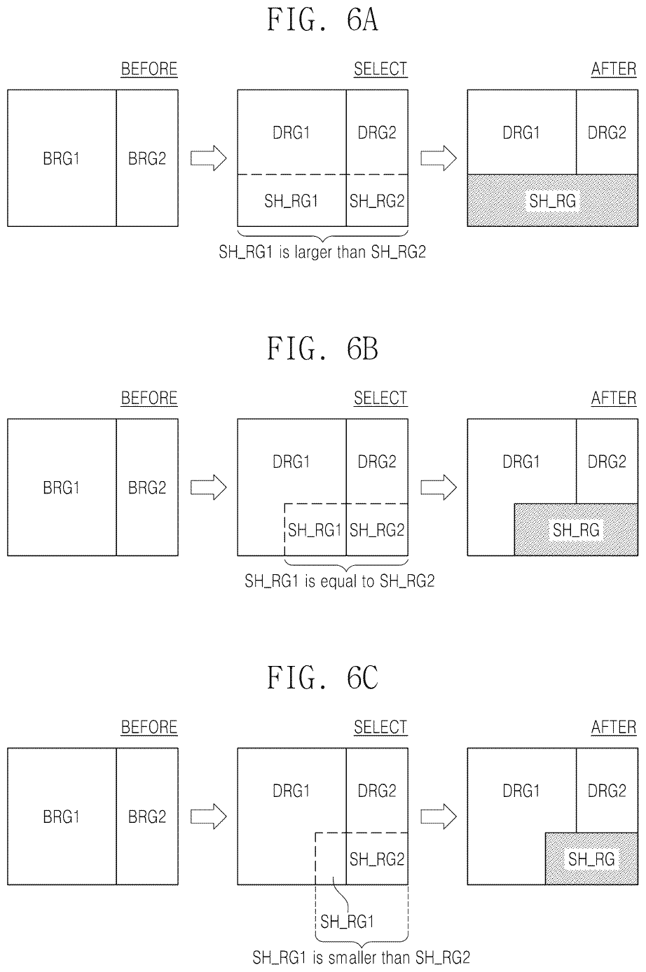

FIGS. 6A to 6C are diagrams illustrating an operation of determining an integrated shared region of the shared buffer memory 113. In FIGS. 6A to 6C, the first buffer region BRG1 is described as being allocated to a first IP block of the storage controller 110 (e.g., a host interface circuit 111), and the second buffer region BRG2 is described as being allocated to a second IP block of the storage controller 110 (e.g., a page copy circuit 115). The first IP block of the storage controller 110 allocated to the first buffer region BRG1 may access the first buffer region BRG1 but may be blocked from accessing the second buffer region BRG2. The second IP block of the storage controller 110 allocated to the second buffer region BRG2 may access the second buffer region BRG2 but may be blocked from accessing the first buffer region BRG1.

First, referring to FIGS. 1, 2, 3, 4, and 6A, the shared buffer memory 113 before determination of the integrated shared region SH_RG may include a first buffer region BRG1 and a second buffer region BRG2 (depicted as BEFORE). In some embodiments, the size of the first buffer region BRG1 may be greater (e.g., larger) than the size of the second buffer region BRG2.

In some embodiments, to determine the integrated shared region SH_RG, the shared buffer manager 114 may select portions of the first and second buffer regions BRG1 and BRG2 of the shared buffer memory 113 (depicted as SELECT). For example, the shared buffer manager 114 may select a first dedicated region DRG1 and a first shared region SH_RG1 from the first buffer region BRG1, and may select a second dedicated region DRG2 and a second shared region SH_RG2 from the second buffer region BRG2. The first dedicated region DRG1 may be a buffer region that allows access only by the first IP block and blocks access by the second IP block. The second dedicated region DRG2 may be a buffer region that allows access only by the second IP block and blocks access by the first IP block. The first shared region SH_RG1 may be a buffer region of the first buffer region BRG1 to be shared with the second IP block. The second shared region SH_RG2 may be a buffer region of the second buffer region BRG2 to be shared with the first IP block. In some embodiments, the size of the selected first shared region SH_RG1 may be greater than the size of the second shared region SH_RG2.

In some embodiments, the shared buffer manager 114 may determine an integrated shared region SH_RG that includes the first shared region SH_RG1 and the second shared region SH_RG2 (depicted as AFTER). The integrated shared region SH_RG may be a buffer region accessible to both the first and second IP blocks. The first IP block may access not only the first dedicated region DRG1 but also the integrated shared region SH_RG, and the second IP block may access not only the second dedicated region DRG2 but also the integrated shared region SH_RG. That is, compared to the state before determination of the integrated shared region SH_RG, the size of the buffer region accessible by the first and second IP blocks of the storage controller 110 may increase after the integrated shared region SH_RG is determined.

Next, referring to FIGS. 1, 2, 3, 4, and 6B, the shared buffer memory 113 before determination of the integrated shared region SH_RG may include a first buffer region BRG1 and a second buffer region BRG2 (depicted as BEFORE). In some embodiments, the size of the first buffer region BRG1 may be greater than the size of the second buffer region BRG2.

In some embodiments, to determine the integrated shared region SH_RG, the shared buffer manager 114 may select portions of the first and second buffer regions BRG1 and BRG2 of the shared buffer memory 113 (depicted as SELECT). For example, the shared buffer manager 114 may select a first dedicated region DRG1 and a first shared region SH_RG1 from the first buffer region BRG1, and may select a second dedicated region DRG2 and a second shared region SH_RG2 from the second buffer region BRG2. In some embodiments, the size of the selected first shared region SH_RG1 may be equal to the size of the second shared region SH_RG2.

In some embodiments, the shared buffer manager 114 may determine an integrated shared region SH_RG that includes the first shared region SH_RG1 and the second shared region SH_RG2 (depicted as AFTER). The integrated shared region SH_RG may be a buffer region accessible to both the first and second IP blocks. The first IP block may access not only the first dedicated region DRG1 but also the integrated shared region SH_RG, and the second IP block may access not only the second dedicated region DRG2 but also the integrated shared region SH_RG. That is, compared to the state before determination of the integrated shared region SH_RG, the size of the buffer region accessible by the first and second IP blocks of the storage controller 110 may increase after the integrated shared region SH_RG is determined.

Compared with FIG. 6A, in FIG. 6B, the size of the dedicated region DRG1 accessed exclusively by the first IP block may increase. For example, because the size of the first shared region SH_RG1 selected in FIG. 6B is smaller than the size of the first shared region SH_RG1 selected in FIG. 6A, the size of the dedicated region DRG1 exclusively accessed by the first IP block may increase.

Finally, referring to FIGS. 1, 2, 3, 4, and 6C, the shared buffer memory 113 before determination of the integrated shared region SH_RG may include a first buffer region BRG1 and a second buffer region BRG2 (depicted as BEFORE). In some embodiments, the size of the first buffer region BRG1 may be greater than the size of the second buffer region BRG2.

In some embodiments, to determine the integrated shared region SH_RG, the shared buffer manager 114 may select portions of the first and second buffer regions BRG1 and BRG2 of the shared buffer memory 113 (depicted as SELECT). For example, the shared buffer manager 114 may select a first dedicated region DRG1 and a first shared region SH_RG1 from the first buffer region BRG1, and may select a second dedicated region DRG2 and a second shared region SH_RG2 from the second buffer region BRG2. In some embodiments, the size of the selected first shared region SH_RG1 may be smaller than the size of the second shared region SH_RG2.

In some embodiments, the shared buffer manager 114 may determine an integrated shared region SH_RG that includes the first shared region SH_RG1 and the second shared region SH_RG2 (depicted as AFTER). The integrated shared region SH_RG may be a buffer region accessible to both the first and second IP blocks. The first IP block may access not only the first dedicated region DRG1 but also the integrated shared region SH_RG, and the second IP block may access not only the second dedicated region DRG2 but also the integrated shared region SH_RG. That is, compared to the state before determination of the integrated shared region SH_RG, the size of the buffer region accessible by the first and second IP blocks of the storage controller 110 may increase after the integrated shared region SH_RG is determined.

Compared with FIGS. 6A and 6B, in FIG. 6C, the size of the dedicated region DRG1 accessed exclusively by the first IP block may increase. For example, because the size of the first shared region SH_RG1 selected in FIG. 6C is smaller than the size of the first shared region SH_RG1 selected in FIGS. 6A and 6B, the size of the dedicated region DRG1 exclusively accessed by the first IP block may increase. The operation of determining the shared region SH_RG of the shared buffer memory 113, in which sizes of the first and second buffer regions BRG1 and BRG2 are different as described with reference to FIGS. 6A to 6C, is merely an example, and the scope of the present disclosure is not limited thereto.

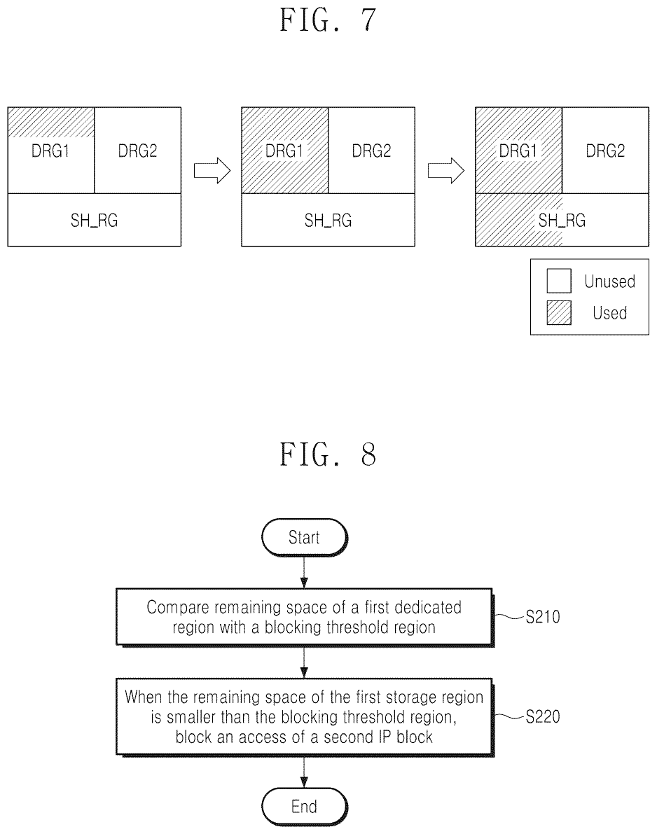

FIG. 7 is a diagram illustrating an order in which buffer regions of the shared buffer memory 113 are used after the integrated shared region is determined. Referring to FIGS. 1 to 7, the shared buffer manager 114 may be in a state in which the integrated shared region SH_RG has been determined. For example, the shared buffer manager 114 may determine the integrated shared region SH_RG by selecting the first shared region SH_RG1 from the first buffer region BRG1 and selecting the second shared region SH_RG2 from the second buffer region BRG2. Hereinafter, the first IP block of the storage controller 110 (e.g., a host interface circuit 111) is described as having priority for access to the integrated shared region SH_RG.

First, the first IP block of the storage controller 110 may first use the first dedicated region DRG1 from among the first dedicated region DRG1 and the integrated shared region SH_RG. Thereafter, when the first IP block of the storage controller 110 has completely used the first dedicated region DRG1, the first IP block of the storage controller 110 may use the integrated shared region SH_RG. That is, among the buffer regions accessible by the first IP block of the storage controller 110, the first dedicated region DRG1 may be used first, and then the integrated shared region SH_RG may be used. Although not illustrated in the drawings, when the second IP block of the storage controller 110 (e.g., the page copy circuit 115) uses the shared buffer memory 113, the second IP block may use the second dedicated region DRG2 first among accessible the buffer regions and then use the integrated shared region SH_RG.

FIG. 8 is a flowchart illustrating an operation of blocking access to the integrated shared region SH_RG. In some embodiments, the flowchart may be implemented by the shared buffer manager at least in part. In FIG. 8, for convenience of description, the first IP block of the storage controller 110 (e.g., a host interface circuit 111) is described as having priority in accessing the integrated shared region SH_RG.

Referring to FIGS. 1 to 8, in step S210, the shared buffer manager 114 may compare the remaining space of the first dedicated region DRG1 with a blocking threshold region. The blocking threshold region may be a threshold region used to determine whether to block access by the second IP block of the storage controller 110 (e.g., the page copy circuit 115) to the integrated shared region SH_RG. When the first IP block of the storage controller 110 has partially used the first dedicated region DRG1, the shared buffer manager 114 may compare the remaining space of the first dedicated region DRG1 with the blocking threshold region.

In step S220, when the remaining space of the first dedicated region DRG1 is smaller than the blocking threshold region, the shared buffer manager 114 may block access by the second IP block of the storage controller 110 to the integrated shared region SH_RG. For example, the shared buffer manager 114 may block access by discarding RQ requests received from the second IP block that are directed to the integrated shared region SH_RG. As the access by the second IP block of the storage controller 110 to the integrated shared region SH_RG is blocked, the first IP block of the storage controller 110 may stably use the integrated shared region SH_RG.

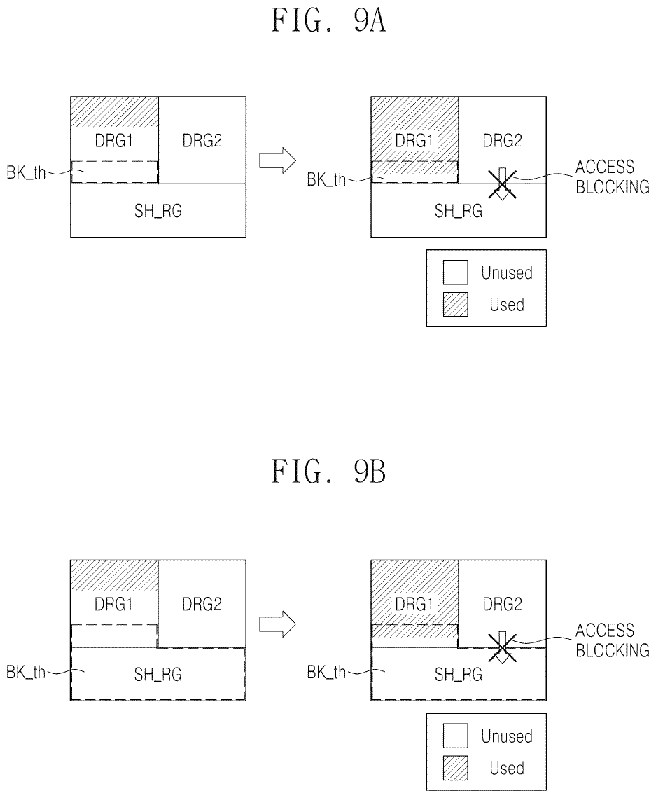

FIGS. 9A and 9B are diagrams illustrating an operation of blocking access to the integrated shared region SH_RG. In FIGS. 9A and 9B, for convenience of description, the first IP block of the storage controller 110 (e.g., the host interface circuit 111) is described as having priority for access to the integrated shared region SH_RG. For example, the shared buffer manager 114 may grant the first IP block priority for access to the integrated shared region SH_RG by preventing RQ requests (e.g., by discarding RQ requests) received from the second IP block that are directed to the integrated shared region SH_RG.

First, referring to FIGS. 1, 2, 3, 4, 7, 8, and 9A, the first IP block of the storage controller 110 (e.g., a host interface circuit 111) may use a portion of the first dedicated region DRG1. The shared buffer manager 114 may compare the remaining space of the first dedicated region DRG1 with a blocking threshold region BK_th. The blocking threshold region BK_th may be a threshold region for determining whether to block access by the second IP block of the storage controller 110 (e.g., a page copy circuit 115) to the shared region SH_RG. The blocking threshold region BK_th may include a portion of the first dedicated region DRG1.

In some embodiments, as the first IP block of the storage controller 110 performs operations, the remaining space of the first dedicated region DRG1 may become smaller than the blocking threshold region BK_th. When the remaining space of the first dedicated region DRG1 becomes smaller than the blocking threshold region BK_th, the shared buffer manager 114 may block access by the second IP block of the storage controller 110 to the integrated shared region SH_RG. Accordingly, the first IP block of the storage controller 110 may stably use the shared region SH_RG.

Next, referring to FIGS. 1, 2, 3, 4, 7, 8, and 9B, the first IP block of the storage controller 110 (e.g., a host interface circuit 111) may use a portion of the first dedicated region DRG1. The shared buffer manager 114 may compare the remaining space of the first dedicated region DRG1 with a blocking threshold region BK_th. The blocking threshold region BK_th may be a threshold region for determining whether to block access by the second IP block of the storage controller 110 (e.g., a page copy circuit 115) to the shared region SH_RG. The blocking threshold region BK_th may include a portion of the first dedicated region DRG1 and the shared region SH_RG. That is, the blocking threshold region BK_th of FIG. 9B may include a larger portion of the integrated shared region SH_RG than the blocking threshold region BK_th of FIG. 9A.

In some embodiments, as the first IP block of the storage controller 110 performs operations, the remaining space of the first dedicated region DRG1 may become smaller than the blocking threshold region BK_th. When the remaining space of the first dedicated region DRG1 becomes smaller than the blocking threshold region BK_th, the shared buffer manager 114 may block access by the second IP block of the storage controller 110 to the integrated shared region SH_RG. Accordingly, the first IP block of the storage controller 110 may reliably use the integrated shared region SH_RG.

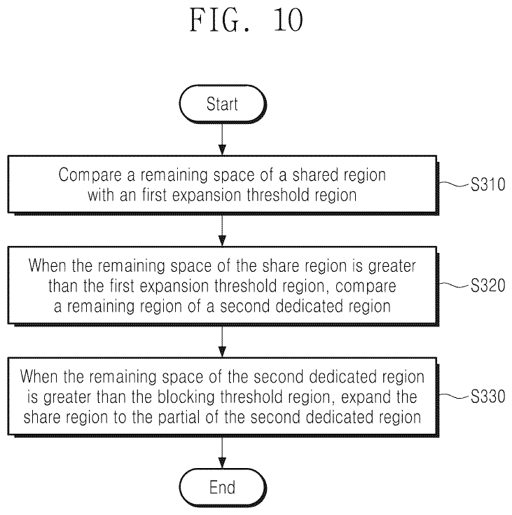

FIG. 10 is a flowchart illustrating an operation of expanding the integrated shared region SH_RG. In FIG. 10, for convenience of description, the first IP block of the storage controller 110 (e.g., a host interface circuit 111) is described as having priority for access to the integrated shared region SH_RG.

Referring to FIGS. 1, 2, 3, 4, 7, 8, and 10, in step S310, the shared buffer manager 114 may compare the remaining space of the integrated shared region SH_RG with a first expansion threshold region. The first expansion threshold region may be a threshold region for determining whether to expand the integrated shared region SH_RG. When the first IP block of the storage controller 110 has fully used the first dedicated region DRG1 and has partially used the integrated shared region SH_RG, the shared buffer manager 114 may compare the remaining space of the integrated shared region SH_RG with the first expansion threshold region.

In step S320, when the remaining space of the integrated shared region SH_RG is smaller than the expansion threshold region, the shared buffer manager 114 may compare the remaining space of the second dedicated region DRG2 with a second expansion threshold region. The second expansion threshold region may be a threshold region for determining whether a portion of the second dedicated region DRG2 may be provided to the integrated shared region SH_RG. In order to determine whether the portion of the second dedicated region DRG2 may be expanded to the shared region SH_RG, the shared buffer manager 114 may compare the remaining space of the second dedicated region DRG2 with the second expansion threshold region.

In step S330, when the remaining space of the second dedicated region DRG2 is greater than the second expansion threshold region, the shared buffer manager 114 may expand the integrated shared region SH_RG by allocating a portion of the second dedicated region DRG2 to the integrated shared region SH_RG. Accordingly, the first IP block of the storage controller 110 may use the increased integrated shared region SH_RG.

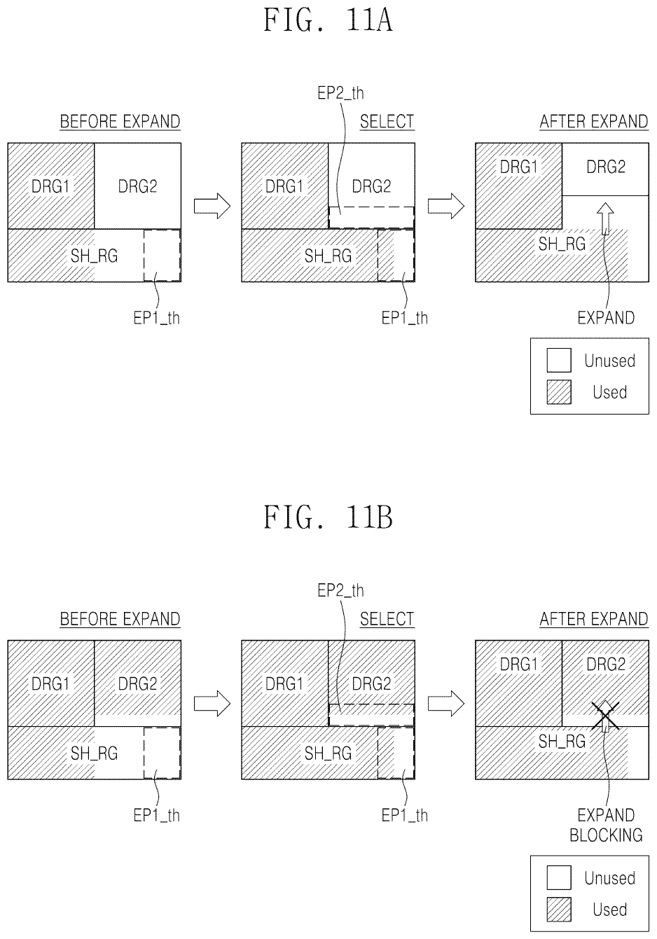

FIGS. 11A and 11B are diagrams illustrating an operation of expanding the integrated shared region SH_RG.

First, referring to FIGS. 1, 2, 3, 4, 7, 8, 10, and 11A, the first IP block of the storage controller 110 (e.g., a host interface circuit 111) may be in a state of using a portion of the integrated shared region SH_RG. For example, after fully using the first dedicated region DRG1, the first IP block of the storage controller 110 may use a portion of the integrated shared region SH_RG.

In some embodiments, the shared buffer manager 114 may compare the remaining space of the integrated shared region SH_RG with a first expansion threshold region EP1_th. The first expansion threshold region EP1_th may be a threshold region for determining whether to expand the integrated shared region SH_RG. The first expansion threshold region EP1_th may include a portion of the integrated shared region SH_RG.

In some embodiments, as the first IP block of the storage controller 110 performs operations, the remaining space of the integrated shared region SH_RG may become smaller than the first expansion threshold region EP1_th. When the remaining space of the integrated shared region SH_RG becomes smaller than the first expansion threshold region EP1_th, the shared buffer manager 114 may compare the remaining space of the second dedicated region DRG2 with a second expansion threshold region EP2_th. The second expansion threshold region EP2_th may be a threshold region for determining whether a portion of the second dedicated region DRG2 may be provided to the integrated shared region SH_RG.

In some embodiments, when the remaining space of the second dedicated region DRG2 is greater than the second expansion threshold region, the shared buffer manager 114 may expand the shared region SH_RG by allocating a portion of the second dedicated region DRG2 to the shared region SH_RG. Accordingly, the first IP block of the storage controller 110 may use the expanded integrated shared region SH_RG.

Next, referring to FIGS. 1, 2, 3, 4, 7, 8, 10, and 11B, the first IP block of the storage controller 110 (e.g., a host interface circuit 111) may be in a state of using a portion of the shared region SH_RG. For example, after fully using the first dedicated region DRG1, the first IP block of the storage controller 110 may use a portion of the integrated shared region SH_RG. The second IP block of the storage controller 110 (e.g., a page copy circuit 115) may be in a state of using a portion of the second dedicated region DRG2.

In some embodiments, the shared buffer manager 114 may compare the remaining space of the integrated shared region SH_RG with a first expansion threshold region EP1_th. The first expansion threshold region EP1_th may be a threshold region for determining whether to expand the integrated shared region SH_RG. The first expansion threshold region EP1_th may include a portion of the integrated shared region SH_RG.

In some embodiments, as the first IP block of the storage controller 110 performs operations, the remaining space of the integrated shared region SH_RG may become smaller than the first expansion threshold region EP1_th. When the remaining space of the integrated shared region SH_RG becomes smaller than the first expansion threshold region EP1_th, the shared buffer manager 114 may compare the remaining space of the second dedicated region DRG2 with a second expansion threshold region EP2_th. The second expansion threshold region EP2_th may be a threshold region for determining whether a portion of the second dedicated region DRG2 may be provided to the integrated shared region SH_RG.

In some embodiments, when the remaining space of the second dedicated region DRG2 is smaller than the second expansion threshold region EP2_th, the shared buffer manager 114 may not expand a portion of the second dedicated region DRG2 to the integrated shared region SH_RG. For example, when the remaining space of the second dedicated region DRG2 is not sufficient to be allocated to the integrated shared region SH_RG, the shared buffer manager 114 may not expand the portion of the second dedicated region DRG2 to the integrated shared region SH_RG.

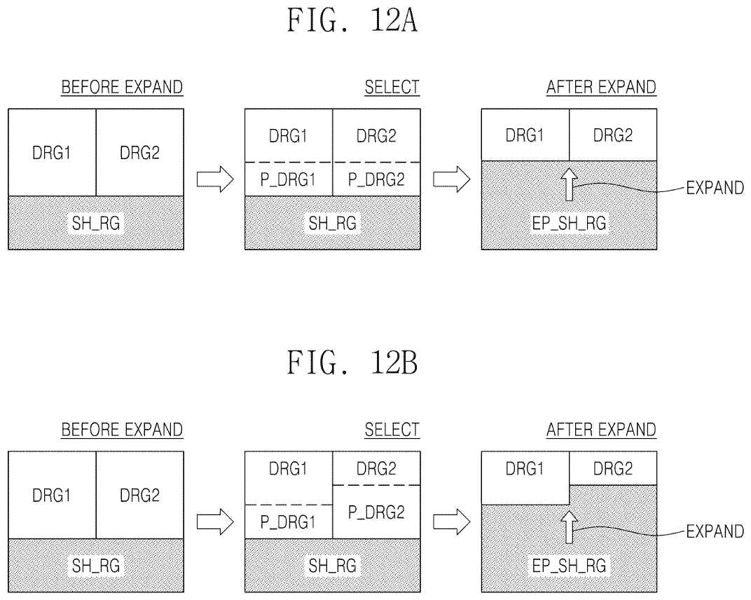

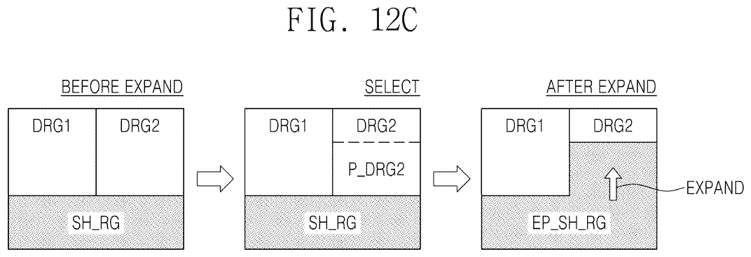

FIGS. 12A to 12C are diagrams illustrating an operation of expanding the integrated shared region SH_RG. In FIGS. 12A to 12C, it is assumed that the first dedicated region DRG1 is allocated to the first IP block of the storage controller 110 (e.g., a host interface circuit 111) and the second dedicated region DRG2 is allocated to the second IP block of the storage controller 110 (e.g., a page copy circuit 115). For example, the first IP block of the storage controller 110 may access the first dedicated region DRG1 and the integrated shared region SH_RG but may be blocked from accessing the second dedicated region DRG2. The second IP block of the storage controller 110 may access the second dedicated region DRG2 and the integrated shared region SH_RG but may be blocked from accessing the first dedicated region DRG1.

First, referring to FIGS. 1, 2, 3, 4, 7, 8, 10, 12A, before expanding the integrated shared region SH_RG, the shared buffer memory 113 may include a first dedicated region DRG1, a second dedicated region DRG2, and the integrated shared region SH_RG (depicted as BEFORE EXPAND). In some embodiments, a size of the first dedicated region DRG1 may be equal to a size of the second dedicated region DRG2.

In some embodiments, in order to expand the integrated shared region SH_RG, the shared buffer manager 114 may select portions of the first and second dedicated regions DRG1 and DRG2 of the shared buffer memory 113 (depicted as SELECT). For example, the shared buffer manager 114 may select a portion P_DRG1 of the first dedicated region DRG1 and may select a portion P_DRG2 of the second dedicated region DRG2. In some embodiments, the selected portion P_DRG1 of the first dedicated region DRG1 and the selected portion P_DRG2 of the second dedicated region DRG2 may have equal sizes.

In some embodiments, the shared buffer manager 114 may determine an expanded integrated shared region EP_SH_RG based on the selected portion P_DRG1 of the first dedicated region DRG1 and the selected portion P_DRG2 of the second dedicated region DRG2 (depicted as AFTER EXPAND). Accordingly, the size of the shared region accessible by the first and second IP blocks of the storage controller 110 may increase.

Next, referring to FIGS. 1, 2, 3, 4, 7, 8, 10, and 12B, before expanding the integrated shared region SH_RG, the shared buffer memory 113 may include a first dedicated region DRG1, a second dedicated region DRG2, and the integrated shared region SH_RG (depicted as BEFORE EXPAND). In some embodiments, a size of the first dedicated region DRG1 may be equal to a size of the second dedicated region DRG2.

In some embodiments, in order to expand the integrated shared region SH_RG, the shared buffer manager 114 may select portions of the first and second dedicated regions DRG1 and DRG2 of the shared buffer memory 113 (depicted as SELECT). For example, the shared buffer manager 114 may select a portion P_DRG1 of the first dedicated region DRG1 and may select a portion P_DRG2 of the second dedicated region DRG2. In some embodiments, a size of the selected portion P_DRG1 of the first dedicated region DRG1 may be smaller than a size of the selected portion P_DRG2 of the second dedicated region DRG2.

In some embodiments, the shared buffer manager 114 may determine an expanded integrated shared region EP_SH_RG based on the selected portion P_DRG1 of the first dedicated region DRG1 and the selected portion P_DRG2 of the second dedicated region DRG2 (depicted as AFTER EXPAND). Accordingly, the size of the shared region accessible by the first and second IP blocks of the storage controller 110 may increase.

Finally, referring to FIGS. 1, 2, 3, 4, 7, 8, 10, and 12C, before expanding the integrated shared region SH_RG, the shared buffer memory 113 may include a first dedicated region DRG1, a second dedicated region DRG2, and the integrated shared region SH_RG (depicted as BEFORE EXPAND). In some embodiments, the size of the first dedicated region DRG1 may be equal to the size of the second dedicated region DRG2.

In some embodiments, in order to expand the integrated shared region SH_RG, the shared buffer manager 114 may select only a portion of the second dedicated region DRG2 without selecting any portion of the first dedicated region DRG1 (depicted as SELECT). For example, the shared buffer manager 114 may select only a portion P_DRG2 of the second dedicated region DRG2. That is, while the shared buffer manager 114 in FIGS. 12A and 12B selects portions of both the first and second dedicated regions DRG1 and DRG2, the shared buffer manager 114 in FIG. 12C may select only one of the first and second dedicated regions DRG1 and DRG2.

In some embodiments, the shared buffer manager 114 may determine an expanded integrated shared region EP_SH_RG based on the selected portion P_DRG2 of the second dedicated region DRG2 (depicted as AFTER EXPAND). Accordingly, the size of the shared region accessible by the first and second IP blocks of the storage controller 110 may increase.

The operation of expanding the integrated shared region of the shared buffer memory, in which the first and second dedicated regions DRG1 and DRG2 have equal sizes as described with reference to FIGS. 12A to 12C, is merely an example, and the scope of the present disclosure is not limited thereto.

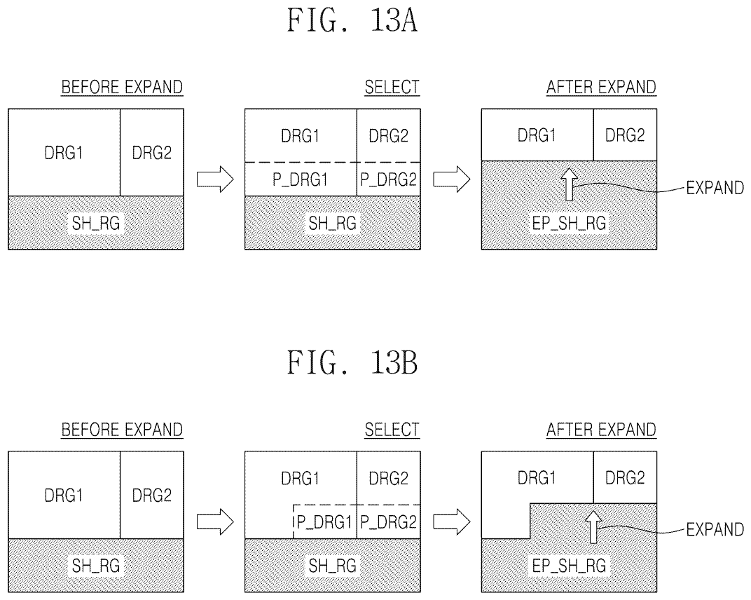

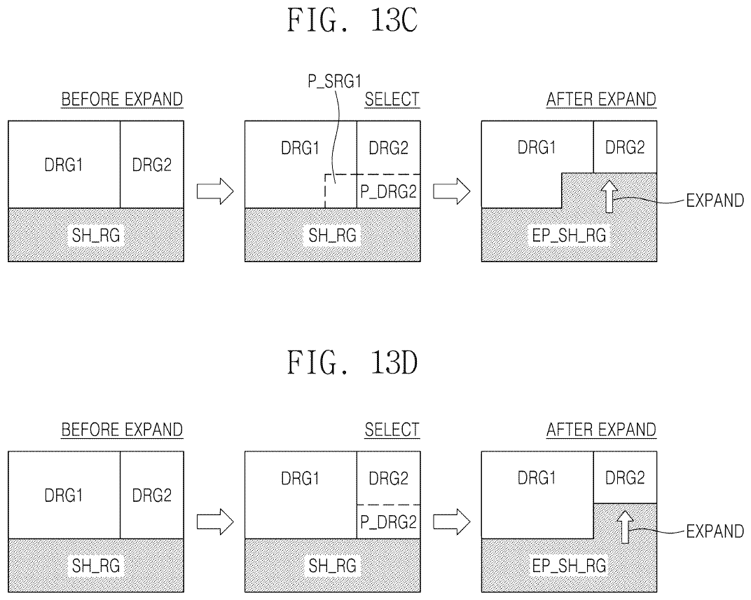

FIGS. 13A to 13D are diagrams illustrating an operation of expanding the integrated shared region SH_RG. In FIGS. 13A to 13C, it is assumed that the first dedicated region DRG1 is allocated to the first IP block of the storage controller 110 (e.g., a host interface circuit 111) and the second dedicated region DRG2 is allocated to the second IP block of the storage controller 110 (e.g., a page copy circuit 115). For example, the first IP block of the storage controller 110 may access the first dedicated region DRG1 and the integrated shared region SH_RG but may be blocked from accessing the second dedicated region DRG2. The second IP block of the storage controller 110 may access the second dedicated region DRG2 and the integrated shared region SH_RG but may be blocked from accessing the first dedicated region DRG1.

First, referring to FIGS. 1, 2, 3, 4, 7, 8, 10, and 13A, before expanding the integrated shared region SH_RG, the shared buffer memory 113 may include a first dedicated region DRG1, a second dedicated region DRG2, and the integrated shared region SH_RG (depicted as BEFORE EXPAND). In some embodiments, the size of the first dedicated region DRG1 may be greater than the size of the second dedicated region DRG2.

In some embodiments, in order to expand the integrated shared region SH_RG, the shared buffer manager 114 may select portions of the first and second dedicated regions DRG1 and DRG2 of the shared buffer memory 113 (depicted as SELECT). For example, the shared buffer manager 114 may select a portion P_DRG1 of the first dedicated region DRG1 and may select a portion P_DRG2 of the second dedicated region DRG2. In some embodiments, the size of the selected portion P_DRG1 of the first dedicated region DRG1 may be greater than the size of the selected portion P_DRG2 of the second dedicated region DRG2.

In some embodiments, the shared buffer manager 114 may determine an expanded integrated shared region EP_SH_RG based on the selected portion P_DRG1 of the first dedicated region DRG1 and the selected portion P_DRG2 of the second dedicated region DRG2 (depicted as AFTER EXPAND). Accordingly, the size of the shared region accessible by the first and second IP blocks of the storage controller 110 may increase.

Next, referring to FIGS. 1, 2, 3, 4, 7, 8, 10, and 13B, before expanding the integrated shared region SH_RG, the shared buffer memory 113 may include a first dedicated region DRG1, a second dedicated region DRG2, and the integrated shared region SH_RG (depicted as BEFORE EXPAND). In some embodiments, the size of the first dedicated region DRG1 may be greater than the size of the second dedicated region DRG2.

In some embodiments, in order to expand the integrated shared region SH_RG, the shared buffer manager 114 may select portions of the first and second dedicated regions DRG1 and DRG2 of the shared buffer memory 113 (depicted as SELECT). For example, the shared buffer manager 114 may select a portion P_DRG1 of the first dedicated region DRG1 and may select a portion P_DRG2 of the second dedicated region DRG2. In some embodiments, the size of the selected portion P_DRG1 of the first dedicated region DRG1 may be equal to the size of the selected portion P_DRG2 of the second dedicated region DRG2.

In some embodiments, the shared buffer manager 114 may determine an expanded integrated shared region EP_SH_RG based on the selected portion P_DRG1 of the first dedicated region DRG1 and the selected portion P_DRG2 of the second dedicated region DRG2 (depicted as AFTER EXPAND). Accordingly, the size of the shared region accessible by the first and second IP blocks of the storage controller 110 may increase.

Next, referring to FIGS. 1, 2, 3, 4, 7, 8, 10, and 13C, before expanding the integrated shared region SH_RG, the shared buffer memory 113 may include a first dedicated region DRG1, a second dedicated region DRG2, and the integrated shared region SH_RG (depicted as BEFORE EXPAND). In some embodiments, the size of the first dedicated region DRG1 may be greater than the size of the second dedicated region DRG2.

In some embodiments, in order to expand the integrated shared region SH_RG, the shared buffer manager 114 may select portions of the first and second dedicated regions DRG1 and DRG2 of the shared buffer memory 113 (depicted as SELECT). For example, the shared buffer manager 114 may select a portion P_DRG1 of the first dedicated region DRG1 and may select a portion P_DRG2 of the second dedicated region DRG2. In some embodiments, the size of the selected portion P_DRG1 of the first dedicated region DRG1 may be smaller than the size of the selected portion P_DRG2 of the second dedicated region DRG2.

In some embodiments, the shared buffer manager 114 may determine an expanded integrated shared region EP_SH_RG based on the selected portion P_DRG1 of the first dedicated region DRG1 and the selected portion P_DRG2 of the second dedicated region DRG2 (depicted as AFTER EXPAND). Accordingly, the size of the shared region accessible by the first and second IP blocks of the storage controller 110 may increase.

Finally, referring to FIGS. 1, 2, 3, 4, 7, 8, 10, and 13D, before expanding the integrated shared region SH_RG, the shared buffer memory 113 may include a first dedicated region DRG1, a second dedicated region DRG2, and the integrated shared region SH_RG (depicted as BEFORE EXPAND). In some embodiments, the size of the first dedicated region DRG1 may be greater than the size of the second dedicated region DRG2.

In some embodiments, in order to expand the integrated shared region SH_RG, the shared buffer manager 114 may select only a portion of the second dedicated region DRG2 without selecting any portion of the first dedicated region DRG1 (depicted as SELECT). For example, the shared buffer manager 114 may select only a portion P_DRG2 of the second dedicated region DRG2. That is, while the shared buffer manager 114 in FIGS. 12A and 12B selects portions of both the first and second dedicated regions DRG1 and DRG2, the shared buffer manager 114 in FIG. 12C may select only one of the first and second dedicated regions DRG1 and DRG2.

In some embodiments, the shared buffer manager 114 may determine an expanded integrated shared region EP_SH_RG based on the selected portion P_DRG2 of the second dedicated region DRG2 (depicted as AFTER EXPAND). Accordingly, the size of the shared region accessible by the first and second IP blocks of the storage controller 110 may increase.

The operation of expanding the integrated shared region of the shared buffer memory, in which the first and second dedicated regions DRG1 and DRG2 have different sizes as described with reference to FIGS. 13A to 13D, is merely an example, and the scope of the present disclosure is not limited thereto.

The foregoing description presents specific embodiments for implementing the present disclosure. The present disclosure is not limited to the above-described embodiments, and may include embodiments that are simply modified in design or easily changed. In addition, the present disclosure may include technologies that may be readily modified and implemented based on the embodiments. Accordingly, the scope of the present disclosure should not be limited to the above-described embodiments, but should be defined by the following claims and equivalents thereof.

A memory system according to some embodiments of the present disclosure may include a storage device including a storage controller, and a host configured to control the storage device, wherein the storage controller includes: a shared buffer memory including a first buffer region and a second buffer region; a first IP block configured to access the first buffer region; a second IP block configured to access the second buffer region; and a shared buffer manager configured to select a first dedicated region and a first shared region from the first buffer region, select a second dedicated region and a second shared region from the second buffer region, determine an integrated shared region including the first shared region and the second shared region and accessed by the first and second IP blocks, determine an access order of the first and second IP blocks to the integrated shared region, compare remaining space of the first dedicated region with a blocking threshold region when the first IP block accesses the integrated shared region, and block access of the second IP block to the integrated shared region when the remaining space of the first dedicated region is smaller than the blocking threshold region, wherein access of the first IP block to the second dedicated region is blocked, and access of the second IP block to the first dedicated region is blocked.

In some embodiments, a size of the first buffer region is equal to a size of the second buffer region.

In some embodiments, the shared buffer manager is further configured to select a first shared region from the first buffer region and to select a second shared region from the second buffer region.

In some embodiments, a size of the first shared region is equal to a size of the second shared region.

In some embodiments, a size of the first shared region is different from a size of the second shared region.

In some embodiments, a size of the first buffer region is different from a size of the second buffer region.

In some embodiments, the blocking threshold region includes a portion of the first dedicated region and the integrated shared region.

What is claimed is:

1. An operation method of a memory device comprising:
selecting a first dedicated region and a first shared region from a first buffer region accessed by a first IP (intellectual property) block of a storage controller;
selecting a second dedicated region and a second shared region from a second buffer region accessed by a second IP block of the storage controller;
determining an integrated shared region including the first shared region and the second shared region, the integrated shared region accessed by the first and second IP blocks;
comparing a remaining space of the first dedicated region with a blocking threshold region when the first IP block accesses the integrated shared region; and
blocking the second IP block from accessing the integrated shared region when the remaining space of the first dedicated region is smaller than the blocking threshold region,
wherein access to the second dedicated region by the first IP block is blocked, and
wherein access to the first dedicated region by the second IP block is blocked.

2. The operation method of claim 1, wherein a size of the first buffer region is equal to a size of the second buffer region, and
wherein a size of the first shared region is equal to a size of the second shared region.

3. The operation method of claim 1, wherein a size of the first buffer region is equal to a size of the second buffer region, and
wherein a size of the first dedicated region is different from a size of the second dedicated region.

4. The operation method of claim 1, wherein a size of the first buffer region is different from a size of the second buffer region, and
wherein a size of the first dedicated region is equal to a size of the second dedicated region.

5. The operation method of claim 1, wherein a size of the first buffer region is different from a size of the second buffer region, and
wherein a size of the first dedicated region is different from a size of the second dedicated region.

6. The operation method of claim 1, wherein the blocking threshold region includes a portion of the first dedicated region.

7. The operation method of claim 1, wherein the blocking threshold region includes a portion of the first dedicated region and the integrated shared region.

8. An operation method of a memory device comprising:
selecting a first dedicated region and a first shared region from a first buffer region accessed by a first IP (intellectual property) block of a storage controller;
selecting a second dedicated region and a second shared region from a second buffer region accessed by a second IP block of the storage controller;
determining an integrated shared region which includes the first shared region and the second shared region, and accessed by the first and second IP blocks;
comparing a remaining space of the integrated shared region with a first expansion threshold region when the first IP block accesses the integrated shared region;
comparing a remaining space of the second dedicated region with a second expansion threshold region when the remaining space of the integrated shared region is smaller than the first expansion threshold region; and
expanding the integrated shared region to include a portion of the second dedicated region when the remaining space of the second dedicated region is larger than the second expansion threshold region,
wherein access to the second dedicated region by the first IP block is blocked,
wherein access to the first dedicated region by the second IP block is blocked,
wherein the first expansion threshold region includes a portion of the integrated shared region, and
wherein the second expansion threshold region includes the portion of the second dedicated region.

9. The operation method of claim 8, wherein a size of the first buffer region is equal to a size of the second buffer region, and
wherein a size of the first shared region is equal to a size of the second shared region.

10. The operation method of claim 8, wherein a size of the first buffer region is equal to a size of the second buffer region, and
wherein a size of the first dedicated region is different from a size of the second dedicated region.

11. The operation method of claim 10, wherein the size of the second dedicated region is larger than the size of the first dedicated region.

12. The operation method of claim 8, wherein a size of the first buffer region is different from a size of the second buffer region, and
wherein a size of the first dedicated region is equal to a size of the second dedicated region.

13. The operation method of claim 8, wherein a size of the first buffer region is different from a size of the second buffer region, and
wherein a size of the first dedicated region is different from a size of the second dedicated region.

14. The operation method of claim 13, wherein the size of the second dedicated region is larger than the size of the first dedicated region.

15. A memory device including a storage controller, the storage controller comprising:
a shared buffer memory including a first buffer region and a second buffer region;
a first IP (intellectual property) block accessing the first buffer region;
a second IP block accessing the second buffer region; and
a shared buffer manager configured to:
select a first dedicated region and a first shared region from the first buffer region,
select a second dedicated region and a second shared region from the second buffer region,
determine an integrated shared region including the first shared region and the second shared region, and accessed by the first and second IP blocks,
compare a remaining space of the first dedicated region with a blocking threshold region when the first IP block accesses the integrated shared region, and
block the second IP block from accessing the integrated shared region when the remaining space of the first dedicated region is smaller than the blocking threshold region,
wherein access to the second dedicated region by the first IP block is blocked, and
wherein access to the first dedicated region by the second IP block is blocked.

16. The memory device of claim 15, wherein a size of the first buffer region is equal to a size of the second buffer region, and
wherein a size of the first shared region is equal to a size of the second shared region.

17. The memory device of claim 15, wherein a size of the first buffer region is equal to a size of the second buffer region, and
wherein a size of the first dedicated region is different from a size of the second dedicated region.

18. The memory device of claim 15, wherein a size of the first buffer region is different from a size of the second buffer region, and
wherein a size of the first dedicated region is equal to a size of the second dedicated region.

19. The memory device of claim 15, wherein a size of the first buffer region is different from a size of the second buffer region, and
wherein a size of the first dedicated region is different from a size of the second dedicated region.

20. The memory device of claim 15, wherein the blocking threshold region includes a portion of the first dedicated region.
